(19) United States
(12) Patent Application Publication
(10) Pub. No.: US 2012/0072103 A1
(43) Pub. Date: Mar. 22, 2012

(54) INFORMATION DISPLAY ARRANGEMENT

(75) Inventor: Fredrik BACKMAN, Frankfurt am Main (DE)

(73) Assignee: GM GLOBAL TECHNOLOGY OPERATIONS LLC, Detroit, MI (US)

(21) Appl. No.: 13/237,031

(22) Filed: Sep. 20, 2011

(30) Foreign Application Priority Data
Sep. 21, 2010 (DE) 102010046124.5

(51) Int. Cl. G01C 21/00; G09G 5/00

(52) U.S. Cl. 701/400; 345/1.1

(57) ABSTRACT

An information display arrangement for a vehicle with a dashboard and a steering arrangement. The steering arrangement includes, but is not limited to a steering facility and a steering column. The information display arrangement includes, but is not limited to a first display facility, which in viewing direction of a vehicle driver is arranged behind the steering facility in the dashboard of the vehicle and the information display arrangement includes, but is not limited to a second display facility that is arranged on the steering column.

### CROSS-REFERENCE TO RELATED APPLICATION

This application claims priority to German Patent Application No. 102010046124.5 filed Sep. 21, 2010, which is incorporated herein by reference in its entirety.

### TECHNICAL FIELD

The technical field relates to an information display arrangement for a vehicle.

### BACKGROUND

Information display devices are arranged in almost all vehicles and as a rule comprise a display facility which is designed to display to a driver information regarding the vehicle and its operation. Thoroughly known are display facilities which are designed as instrument panels. These are mostly arranged in a dashboard behind a steering wheel and display to the driver so-called primary information which among other things comprise information regarding speed, rotational speed and tank filling level.

Also known are information devices with two or more display facilities. The publication DE 102 41 837 A1, which probably forms the closes prior art, describes a driver information system for a vehicle with a first and optionally in addition a second display, which is arranged stationary on an impact pad of the steering wheel and designed to display the primary information. In addition, a display of the primary information on a head-up display on the windshield can be affected to improve the driver information system.

At least one object is to provide an information display arrangement that is improved in functional and ergonomic respect. In addition, other objects, desirable features and characteristics will become apparent from the subsequent summary and detailed description, and the appended claims, taken in conjunction with the accompanying drawings and this background.

### SUMMARY

An information display arrangement is proposed for a vehicle. The information display arrangement is designed to display and/or visualize in compacted form information and/or instructions to a vehicle driver and/or additional vehicle occupants. Usually, the information display arrangement comprises an evaluation device and a control device. The evaluation device is designed to evaluate user inputs. The control device is preferentially designed to control the information display arrangement and its functions according to the user inputs.

The vehicle is preferentially designed as passenger car or commercial vehicle. It comprises a dashboard which is preferentially designed as display, instrument and/or system panel. The dashboard is more preferably arranged in viewing direction of a vehicle driver seated on a vehicle seat. Usually the dashboard is arranged below a windshield. The designation “below” in the following also describes a direction which is directed from a vehicle roof to a vehicle floor. The designation “above” in the following describes the direction which is directed from the vehicle floor to the vehicle roof.

The vehicle comprises a steering arrangement which comprises a steering facility and a steering column. The steering facility is preferentially designed as a steering wheel with a steering wheel rim and steering wheel spokes. Optionally, the steering facility can be designed as steering lever or as another suitable steering instrument. The steering facility is more preferably fastened in the vehicle in the steering column and/or the steering column connects the steering facility at least visually to the dashboard. Usually, the steering column with mechanical systems comprises a covering which envelopes and covers the steering shaft towards the vehicle interior. In the case of electronic systems (steer-by wire) the steering column only forms a design connection between steering facility and dashboard.

The information display arrangement comprises a first display facility, which in viewing direction of the vehicle driver is arranged behind the steering facility, more preferably behind the steering wheel, in the dashboard. Preferentially, the first display facility is arranged below and/or adjacent to the windshield. More preferably, the first display facility is visible to the vehicle driver above or at the height of the steering wheel rim, wherein this can be particularly dependent on a height adjustment of the steering wheel. The first display facility can have any shape and can thus be adapted to an interior design of the vehicle. Preferred is a rectangular, oval or semi-spherical outer contour of the first display facility.

The information display arrangement comprises a second display facility which is arranged on the steering column. Preferentially, the second display facility is arranged stationarily, particularly rigidly, between the dashboard and the steering facility. It is also possible that the second display facility is mounted on the steering column in a moveable and/or pivotable manner. More preferably, the second display facility is visible to the vehicle driver through openings between the steering wheel spokes. It is conceivable that the second display facility has a square, rectangular, oval or circular outer contour. All other suitable shapes, which like the first display facility can be adapted to the interior design of the vehicle, are likewise possible.

In particular, the first and second and optionally one or a plurality of further display facilities can be designed as electrical and/or electronic displays. It is particularly preferable that the display facilities are designed as monitor and/or display, for example as a liquid crystal display (LCD), an active matrix display (TFT display) and/or as a fluorescence display. More preferably, the display facilities are designed to visually represent displays, particularly characters, figures, images and/or symbols. It is conceivable that the display facilities comprise display and/or signal lights and/or are complemented by these. The display and/or signal lights can for example be formed through light emitting dials (LEDs) and/or organic light emitting diodes (OELDs).

It is advantageous that the information display arrangement comprises two display facilities, which can visualize different and thus a multiplicity of information. The two display facilities are preferentially arranged in a main field of vision of the vehicle driver, more preferably in a viewing direction on to the steering facility, the dashboard and/or the windshield. In that the first and second display facility is arranged in as large as possible a distance from the vehicle driver the information display arrangement is adapted to an ergonomic of the vehicle driver in an optimized manner. This favors that the information shown on the first and second display facility can be perceived by the vehicle driver in a fraction of a second, preferentially within approximately 0.3 seconds, more preferably within approximately 0.2 seconds. The ergonomic arrangement of the first and second display facility can advantageously counteract a tiring of the vehicle driver, particularly through (over) loading of an eye activity of the vehicle driver. Through a more relaxed driving accidents due to overtiring and/or concentration deficits of the vehicle driver can be avoided.

It is furthermore advantageous that the first and second display facility because of an extensive flexibility can be adapted in size and/or shape to almost any interior design of the vehicle. Through this expanded design freedom an orientation to individual customer desires it becomes possible, as a result of which a customer interest can be roused and if applicable a vehicle value increased.

In an embodiment there is a first eye distance between the first display facility and the vehicle driver and a second eye distance between the second display facility and the vehicle driver. The second eye distance is shorter than the first eye distance. More preferably, the first and second display facilities are arranged offset with respect to each other in viewing direction of the vehicle driver and/or in the eye distance to the vehicle driver.

An embodiment provides that the second display facility is arranged below the first display facility. Preferentially, the first and the second display facility are arranged offset in height. Thus it can be advantageously guaranteed that the second display facility does not obscure the first display facility.

In another embodiment the information display arrangement comprises a third display facility which is arranged in a windshield of the vehicle. Preferentially, the third display facility is integrated in the windshield as a head-up display. The third display facility is more preferably formed through a display field, which is directed on a roadway in viewing direction of the vehicle driver. Preferentially, the third display facility is arranged above the first display facility. More preferably, the third display facility comprises at least partially a greater eye distance to the vehicle driver than the first display facility. Specifically, the information and/or instructions displayed on the third display facility can be preferentially perceived by the vehicle driver within approximately 0.5 seconds, more preferably within approximately 0.3 seconds.

In another embodiment the information display arrangement comprises a fourth display facility which is arranged adjacent to and/or next to the first display facility in the dashboard. Preferentially, the fourth display facility extends along a still remaining dashboard portion, preferentially on a co-driver's side of the vehicle. Specifically, the fourth display facility is arranged in the middle in the dashboard and/or in front of a co-driver's seat in the vehicle interior. Optionally, the fourth display facility comprises an elongated rectangular or oval shape.

A further embodiment provides that at least two of the four display facilities are arranged step-like in the vehicle interior, more preferably in viewing direction of the vehicle driver. Preferentially, the third display facility is arranged uppermost and at least partially with greatest eye distance to the vehicle driver. More preferably, the first and optionally additionally the fourth display facility are arranged below the third display facility. The first and optionally the fourth display facility preferentially comprise a smaller eye distance to the vehicle driver than the third display facility. Specifically, the second display facility is arranged lowermost and comprises the smallest eye distance to the vehicle driver.

Optionally, the display facilities can be arranged perspectively overlapping or adjoining each other. Preferentially, the display facilities are arranged above, below and/or laterally spaced from each other or they seamlessly adjoin each other on at least one side and/or in at least one direction. However, it is conceivable that a display facility laterally, above and/or below overlaps at least one other display facility. For example, the displays of one or a plurality of display facilities are continued in the display of another or a plurality of other display facilities. More preferably, the display of the first display facility can visually extend into the windshield and overlap the display of the third display facility. Specifically, the extending display of the first display facility can be taken over by the third display facility and continued. Obviously, the displays of the second, third and/or fourth display facility can also be continued in one or a plurality of displays. Thus, it is conceivable for example that the second display facility overlaps the first and/or the fourth display facility overlaps the third and that their displays are mutually continued and/or displayed. All other conceivable variations are likewise possible.

In a fourth embodiment the first display facility is designed for the display of primary information. The primary information preferentially comprises operating and/or status information such as for example a speed and/or rotational speed display, an energy reservoir and/or tank filling level display, a range display of the vehicle, various indication displays, an external temperature and/or time display and much more.

A further embodiment provides that the second display facility is designed for the display of secondary information. It is particularly preferred that the second display facility is designed in order to display additional and different information than the first display facility. The secondary information preferentially comprises information individually and accurately adjustable by the vehicle driver. For example, the secondary information can comprise displays regarding or with respect to mobile devices used in the vehicle, for example mobile telephones and/or smart phones. More preferably, the secondary information comprises internet displays such as for example websites, mailbox and/or accumulator information of the mobile telephone individually selectable by the vehicle driver. Also possible are displays regarding the second display facility, which comprise information regarding an air conditioning system and/or regarding a radio in the vehicle.

Preferentially, the third display facility is designed for the display of navigation and/or warning instructions. To this end, the vehicle is usually equipped with approximation sensors and/or a camera on one or a plurality of vehicle outsides. More preferably, a GPS receiver is installed in the vehicle. Specifically, the navigation displays comprise direction information, route displays, street names, congestion warnings, etc. The warning instructions preferentially comprise instructions regarding traffic signs, persons, obstacles or additional vehicles on the roadway, more preferably collision warnings. Preferentially, these are immediately displayed on the third display facility as soon as these appear in the surroundings of the vehicle and/or are sensed by the approximation sensors and/or the camera. It is conceivable that the displays, more preferably the navigation and/or warning instructions are carried out in a three-dimensional representation.

More preferably, the fourth display facility is designed for the display of rear-end information. Preferentially, the fourth display facility is designed to display to the vehicle driver and if applicable, a co-driver the traffic and a course of the road behind the vehicle. It is also conceivable that a warning instruction is effected before an impending rear-end accident through a vehicle coming from the back or that the fourth display facility serves as a parking aid. Optionally, the fourth display facility can replace or supplement a function of a rear-view mirror. To this end, the vehicle is more preferably likewise equipped with approximation sensors and/or the camera on a rear outside.

Preferentially, the information display arrangement is designed to reduce a load on a vehicle driver upon a visual perception of the primary, secondary and/or rear-end information and/or with the visual perception of the navigation and/or warning instructions. To this end, it is advantageous that the at least two display facilities with regard to the vehicle floor are arranged as high as possible in the vehicle interior. More preferably, the at least two display facilities are arranged in viewing direction of the vehicle driver and as far as possible away from said vehicle driver. This already described step-like arrangement of the display facilities in the vehicle interior can be advantageously reduce an adjusting time of eye and/or pupils of the vehicle driver to changed light conditions. In addition, an eye and/or pupil adaptation, particularly of a load through a focusing on objects, persons and/or the traffic outside the vehicle, and the load through the focusing on the displays on the display facilities in the interior of the vehicle can be reduced. Tiring of the vehicle driver caused by an intensified eye activity for perceiving the road traffic and the information on the display facilities can be delayed. Because of this it is made possible to maintain a concentration ability of the vehicle driver for a longer period of time and to minimize accident hazards.

A further advantage is that particularly the displays of the third and fourth display facility are visible to additional vehicle occupants. Because of this it is made possible that the occupants can remain in contact with the vehicle driver and can accurately assess the driving events. Preferentially, the displays provide more entertainment for the occupants and the vehicle driver while driving.

In a further embodiment the information display arrangement comprises an operating device for operating at least one of the four display facilities. The operating device is arranged within a semi-circular arm movement range of the vehicle driver. Preferentially, the semi-circular arm movement range is formed through a movement of one or both arms of the vehicle driver in the direction of the steering wheel, while the vehicle driver is located on a driver's seat. More preferably, a palm of the vehicle driver is directed towards the steering device during the semi-circular arm movement, while the palm can touch the touch-sensitive surface in this posture.

Optionally, the operating device is arranged on, next to and/or adjacent to the steering arrangement. Preferentially, the operating device is arranged on the steering device or on the steering column and/or connected to the latter. For example, the operating device can be arranged next to/or behind a steering wheel rim. More preferably, the operating device is arranged in such a manner that between said operating device and a hand of the vehicle driver which usually operates the steering facility there are a small distance and/or short paths.

It is conceivable that two operating facilities are arranged in the vehicle interior, particularly on and/or adjacent to the steering arrangement. It is conceivable that the two operating facilities are arranged on both sides, particularly on from a view of the vehicle driver left and right side of the steering column and/or steering facility. It is conceivable that the first display facility can be operated through the operating facility on the left side and the second display facility through the operating facility on the right side of the steering column.

In a possible further embodiment the operating facility is designed as a connecting arm, lever or pad or the operating facility forms a constituent part of the connecting arm, lever or pad. The connecting arm is preferentially fastened in a statically fixed manner to the steering arrangement and/or connected to the latter. Alternatively, the lever is more preferably designed moveable, e.g., as multi-functional control lever and additionally designed for the activation of a vehicle light and/or indicator. The pad can for example be arranged on the steering wheel rim and/or stand away from the latter.

The operating facility can be easily reached by the vehicle driver which in an advantageous manner can reduce a physical load on the vehicle driver. Furthermore, the vehicle driver is not occasioned to cast his view away from the road while driving or take is hands completely off the steering wheel. Preferentially, the vehicle driver can utilize ergonomic synergy effects which occur between the arrangement of the display facilities and the arrangement of the operating facility. Both facilities are more preferably designed to reduce the tiring and inattentiveness of the vehicle driver and avoid accidents resulting therefrom.

It is particularly preferred that the operating facility comprises at least one touch-sensitive surface or is formed by such. Preferentially, the surface is arranged on an outer end of the connecting arm or lever or on a top side of the pad. More preferably, the touch-sensitive surface is directed towards a vehicle door, specifically to a driver and/or co-driver's door. It is particularly preferred that the touch-sensitive surface is oriented radially to a center of the steering facility, to an axis of rotation of the steering wheel. Preferentially, the touch-sensitive surface is arranged parallel to the driver's and/or co-driver's door. More preferably, an intermediate angle of preferentially up to approximately 45 degrees, particularly up to approximately 30 degrees, specifically up to approximately 15 degrees can exist between the touch-sensitive surface and the driver's and/or co-driver's door. Specifically, the touch-sensitive surface is not directed in the direction of the vehicle driver, particularly not to a vehicle rear-end. Usually, the touch-sensitive surface is not completely visible to the vehicle driver when he is located on a driver's seat. Preferentially, the touch-sensitive surface is visible to the vehicle driver on the driver's seat in a perspective view only preferentially to approximately 30%, particularly to approximately 20%, specifically to approximately 10%. More preferably, the touch-sensitive surface is designed circular or oval. Any other ergonomically suitable surface shape, such as a square or rectangular surface is also conceivable.

It is particularly preferred that the operating facility is at least partially designed as a touchpad, particularly as a conductive infrared touchpad, specifically without additional switches and/or buttons. More preferably, the operating facility, specifically the touch-sensitive surface is designed in order to activate and/or operate the display facilities by tipping on it once or twice or by a direction-guided stroking movement. Accordingly, the touch-sensitive surface makes possible that the vehicle driver can comfortably, securely and intuitively apply and operate the operating facility and the display facilities. However, it cannot be entirely excluded that the operating facility can comprise operating keys and/or buttons and/or rotary and/or rocker switches.

Preferentially, the display facilities are operable and controllable by the vehicle driver through a touch, particularly by tipping on the touch-sensitive surface once or twice or through the direction-guided stroking motion on the surface. Preferentially, the at least one display facility is activatable by tipping on the touch-sensitive surface once. Alternatively, the vehicle driver can select or mark the display or a leading link by tipping on it once. More preferably, the display can be selected and/or the link on the display activated by tipping on it twice. With the direction-guided stroking motion over the touch-sensitive surface the vehicle driver can for example guide a cursor over the display facility or change settings more preferably in their intensity displayed there.

For example, the second display facility is initially activatable through the once-off tipping on the touch-sensitive surface. Preferentially, following the activation a selection menu with numerous links to the remaining display facilities or to the information and/or instructions from which the vehicle driver can select will appear on the second display facility. Through the direction-guided stroking motion the vehicle driver is able for example to move a cursor onto one of the links. Optionally, the vehicle driver can select the desired link by tipping on it twice. Thus a further display facility can be activated and/or the selected display will appear on the second display facility. It is likewise conceivable that the vehicle driver through the touch, particularly through the direction-guided stroking motion can adjust a volume of the radio, an interior temperature or a blower intensity.

In a further embodiment the touch-sensitive surface comprises approximation sensors that sense an approach of the hand of the vehicle driver. Preferentially, the at least one display facility is switched on even while the hand approximates the touch-sensitive surface, while it displays the selection menu. In another embodiment the touch-sensitive surface comprises a first and a second touch-sensitive surface portion. More preferably, the first surface portion can be arranged next to the second surface portion, while they mutually complement each other to the touch-sensitive surface. For example, both surface portions are designed in a semi-circular shape and together form the circular or oval surface. It is also conceivable that the second surface portion has a smaller surface area than the first one. Optionally, the second surface portion is arranged on the first surface portion, while it conceals a part of the first surface portion.

Preferentially, different display facilities can be activated and/or operated with the first and second surface portion. It is conceivable that the vehicle driver by touching the first surface portion can select the first display facility and by touching the second surface portion, the second display facility. More preferably, by touching the first and second surface portion the input of different commands through the vehicle driver is made possible. It is quite possible that the vehicle driver with the first surface portion can make a selection between the individual display facilities and with the second surface portion can operate and/or change the information and/or instructions.

In another embodiment the touch-sensitive surface is designed illuminable. It is also possible that only a surface portion is illuminable or illuminated or that the first surface portion is illuminable or illuminated in another light color than the second one. For example, the first surface portion is illuminated red if it or the display facility/facilities to be operated therewith is/are deactivated. The second surface portion can be illuminated green when it is ready for operation or when the display facility/facilities to be operated therewith are activated. It is likewise conceivable that the touch-sensitive surface or a surface portion lights up in the cycle of an activated indicator. It is preferable that exactly the touch-sensitive surface, which is arranged on the same vehicle side on which the indicator has also been activated, lights up. It is likewise conceivable that a regular flashing of the touch-sensitive surface can announce an incoming call on a mobile radio device carried along in the vehicle.

The information display arrangement, particularly the operating facility, preferentially offers an individually operable user interface with which personal settings and functions can be selected and displayed on the display facilities. The use of future technologies such as for example the integration of the touchpad and/or LC display in the vehicle interior can co-determine the design of the vehicle in an advantageous manner. Specifically, the information display arrangement is arranged ergonomically advantageous and in a space-saving manner, as a result of which the vehicle interior can be designed more generous.

### BRIEF DESCRIPTION OF THE DRAWINGS

The present invention will hereinafter be described in conjunction with the following drawing figures, wherein like numerals denote like elements, and:

FIG. 1 is a schematic lateral view of an information display arrangement in a vehicle interior;

FIG. 2 is a schematic front view of the information display arrangement from FIG. 1 in the vehicle interior;

FIG. 3 is a further front view of the information display arrangement from FIG. 2 in the vehicle interior; and

FIG. 4 is a front view of a steering facility and an operating facility.

### DETAILED DESCRIPTION

The following detailed description is merely exemplary in nature and is not intended to limit application and uses. Furthermore, there is no intention to be bound by any theory presented in the preceding background or summary or the following detailed description.

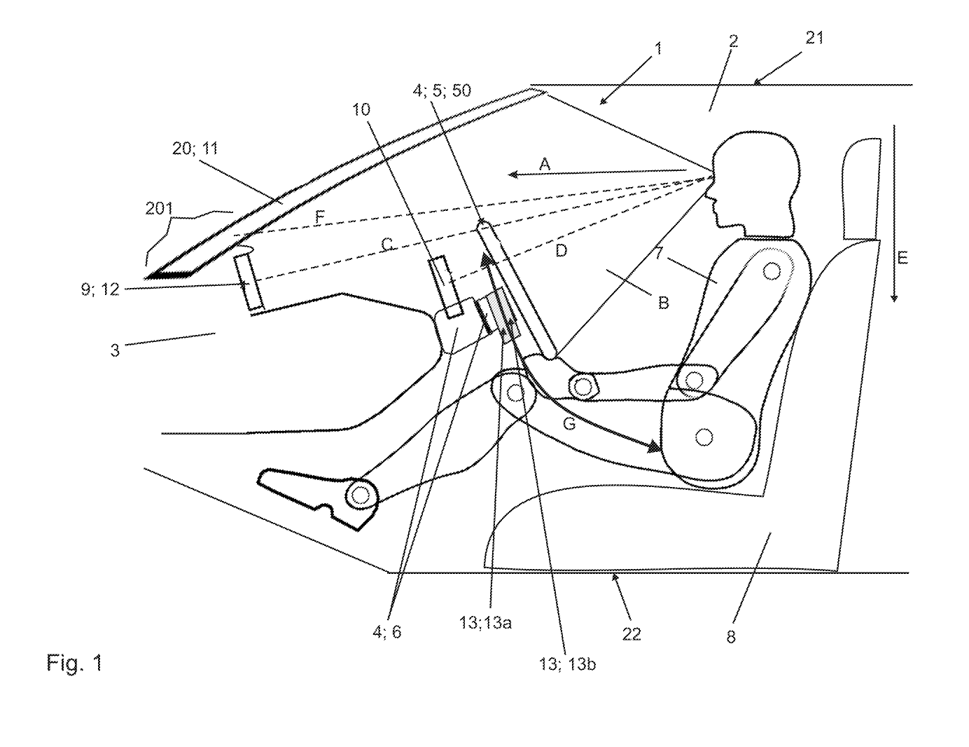

FIG. 1 shows a schematic lateral view of an information display arrangement 1 in a vehicle interior. More preferably, a driver's side of a passenger car is shown as an embodiment. The information display arrangement 1 is arranged in a front region of the vehicle interior 2 that is delimited by a windshield 20, a vehicle roof 21 and a vehicle floor 22. Below the windshield 20, particularly in direction of the vehicle roof 21 to the vehicle floor 22 a dashboard 3 and a steering arrangement 4 are arranged. The steering arrangement 4 comprises a steering facility 5 and a steering column 6. The steering facility 5 is designed as a steering facility 5 with a steering wheel rim 50. The steering column 6 is designed in order to connect the steering facility 5 to the dashboard 3.

A vehicle driver 7 is present in the vehicle interior 2 on a driver's seat 8 in front of the steering facility 5 and looks in the direction of the windshield 20 (viewing direction according to arrow A). The information display arrangement 1 comprises a first display facility 9 which in viewing direction (according to arrow A) of the vehicle driver 7 is arranged behind the steering facility 5 in the dashboard 3. The first display facility 9 is arranged visible to the vehicle driver 7 above the steering wheel rim 50 and in a field of vision B of the vehicle driver 7.

The information display arrangement 1 comprises a second display facility 10, which is arranged on the steering column 6. The second display facility 10 like the first display facility 9 is arranged in the field of vision B of the vehicle driver 7. The second display facility 10 is (according to arrow E) arranged below the first display facility 9.

The first and second display facility 9; 10 are arranged offset in the viewing direction (according to arrow A) of the vehicle driver 7, more preferably offset behind each other. Between the first display facility 9 and the vehicle driver 7 there is a first eye distance C. Between the second display facility 10 and the vehicle driver 7 there is a second eye distance D. The second eye distance D is smaller than the first eye distance C. Because of this, the first display facility 9 can be designated as “far away screen” and the second display facility 10 as “close screen”. The information display arrangement 1 comprises a third display facility 11, which is integrated in the windshield 20. The third display facility 11 is designed as a head-up display and at least partially arranged above (against arrow E) of the first and second display facility 9; 10 in the field of vision B of the vehicle driver 7. Furthermore, the information display arrangement 1 comprises a fourth display facility 12, which is arranged adjacent and next to the first display facility in the dashboard 3. Thus, it is likewise arranged in the field of vision B of the vehicle driver 7.

The four display facilities 9; 10; 11; 12 are partially arranged step-like to one another in the vehicle interior 2, while the third display facility 11 is arranged as uppermost (against arrow E) and in a third eye distance F to the vehicle driver. The third eye distance F is variable with a curvature of the windshield 20 and decreases in the direction of the vehicle roof 21. At least in one windshield portion 201, which is arranged behind (according to arrow A) the first display facility 9 in the windshield 20, the third eye distance F is greater than the first eye distance C. The first and fourth display facility 9; 12 are arranged below (according to arrow E) the third display facility 11. The second display facility 10 is arranged below the first and fourth display facility 9; 12. In addition, the second eye distance D is smaller than the first eye distance C.

Consequently, the third display facility 11 is arranged on a last and/or uppermost imaginary step in the vehicle interior 2. At least in the windshield portion 201, this display facility 11 has the greatest eye distance F to the vehicle driver 7. Accordingly, the first and fourth display facility 9; 12 is arranged on the middle step and the second display facility 10 on the lowermost step. The lowermost step has the smallest eye distance D to the vehicle driver 7.

The information display arrangement 1 comprises an operating facility 13 which is arranged next to and/or adjacent to the steering arrangement 4. The operating facility 13 is arranged in a semi-circular arm movement range G of the vehicle driver 7 in the vehicle interior 2, as a result of which it is attached ergonomically advantageously and within reach of the vehicle driver 7. A short distance between the steering facility 5 and the operating facility 13, and the semi-circular arm movement direction G of the vehicle driver 7 promote a physical and mental relief and help avoid tiring, inattentiveness and accidents.

The operating facility 13 is formed through a touch-sensitive surface 13 having a rectangular outer contour and which is designed as a conductive infrared touchpad 13. When touching the touchpad at least one of the display facilities 9; 10; 11; 12 can be activated and operated. The touch-sensitive surface 13 comprises two rectangular part surfaces 13a and 13b which are arranged next to each other. By touching the first part surface 13a the first and second display facility 9; 10 can b activated and operated. By touching the second part surface 13b the third and fourth display facility can be activated and operated.

In an alternative embodiment the vehicle driver by touching the first part surface 13 can make a selection among the display facilities 9; 10; 11, 12 and by touching the second part surface 13b select, call up or change information and/or instructions on the selected display facility 9; 10; 11; 12. The touch-sensitive part surfaces 13a; b are designed illuminable. When touching one of the two part surfaces 13a; b the touched part surface lights up.

The four display facilities 9; 10; 11; 12 are designed as liquid crystal displays (LCDs) to display displays, particularly letters, figs., images and/or symbols. The operating device 13 is designed to activate and to operate the display facilities 9; 10; 11; 12. The part surfaces 13a; 13b comprise different functions which are activatable through a touch, more preferably one or a plurality of tipping and/or directional movements of the vehicle driver 7.

The information display arrangement 1 is designed in order to reduce a load on a vehicle driver 7 during a visual perception of the displays on the display facilities 9; 10; 11; 12. Through the partial step-like arrangement the display facilities 9; 10; 11; 12 in each case are arranged with the greatest possible eye distance C; D; F to the vehicle driver, as a result of which the physical load on the vehicle driver 7 particularly through reduced adaptation and/or focusing movements of the eyes can be minimized. In the vehicle interior 2 ergonomically advantageous synergy effects between the display facilities 9; 10; 11; 12 and the operating device 13 can be realized through the step-like arrangement of the display facilities 9; 10; 11; 12 and through the arrangement of the operating facility 13 in the semi-circular movement range G.

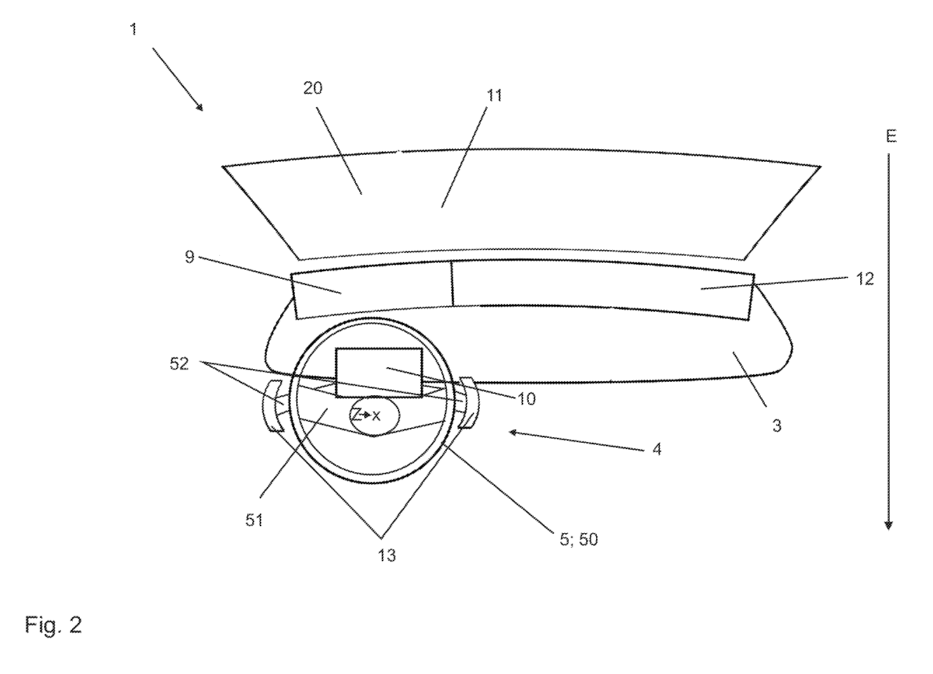

FIG. 2 shows a schematic front view of the information display arrangement 1 from FIG. 1 and in particular the field of vision B of the vehicle driver 7 seated on the driver's seat 8. The third display facility 11 is integrated as head-up display in the windshield 20 of the vehicle. Below the third display facility 11 (according to arrow E) the first display facility 9 is arranged on the driver's side in the dashboard 3. The first display facility 9 is arranged above (against arrow E) of the steering facility 5, particularly above the steering wheel rim 50.

Next to the first display facility 9 the fourth display facility 12 is arranged in the dashboard 3. The fourth display facility 12 extends from a dashboard middle as far as to the co-driver's side. It is visible to the vehicle driver 7 without or through a minor eye and/or head movement.

The second display facility 10 is arranged below (according to arrow E) the first display facility 9. It is attached to the steering arrangement 4, particularly the steering column 6 and visible to the vehicle driver 7 through the spokes 51 of the steering facility 5. The operating device is formed by two touch-sensitive surfaces 13, which are arranged radially to an imaginary straight line through a center Z of the steering facility 5, particularly to an axis of rotation about which the steering facility 5 rotates. The touch-sensitive surfaces 13 are arranged on outer ends of two connecting arms 52 which are attached on a left and right side of the steering column 6 and are moveably connected to the latter.

The touch-sensitive surface 13, which is arranged on the connecting arm 52 attached on the left is directed towards a driver's door (not shown). The touch-sensitive surface 13 arranged on the connecting arm 52 attached on the right is directed towards a co-driver's door (not shown). The touch-sensitive surfaces 13 have a radius or a bend that is adapted to the radius of the steering wheel rim 50. The connecting arms 52 are designed as multi-functional control levers which are designed for activating indicators and/or headlamps of the vehicle.

The touch-sensitive surfaces 13 are designed illuminable. Upon activation of the indicator on a right vehicle side the touch-sensitive surface 13 arranged on the right lights up in the rhythm of the indicator. Exactly the same occurs when the indicator on the left vehicle side is activated. The touch-sensitive surface 13 arranged on the left will then be flashing.

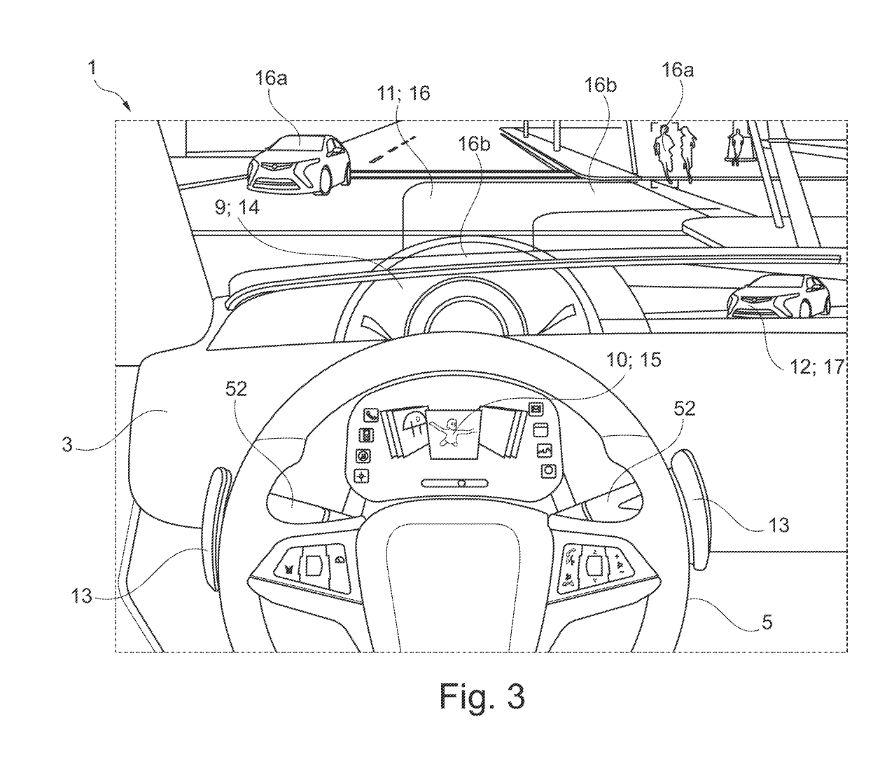

FIG. 3 shows a further front view of the information display arrangement 1 from FIG. 2 in the field of vision B of the vehicle driver 7. The first display facility 9 is designed for a display of primary information 14 such as speed, rotational speed, tank filling level, range, etc. In a perspective, the first display facility 9 overlaps the third display facility 11 in that the display of the first display facility 9 is continued on the third display facility 11.

The second display facility 10 is designed in order to display secondary information 15. The secondary information 15 comprises individual displays such as for example freely selectable websites of the internet or displays regarding mobile devices carried along in the vehicle, such as for example mobile telephones. Also possible is information regarding an air conditioning system or a radio unit. The third display facility 11 is designed to display navigation and/or warning instructions 16. The navigation instructions 16a comprise the information of a navigation system installed or carried along in the vehicle, such as for example the display of the direction or of the course of the road, the provision of street names and/or designations of public facilities and/or points of interest, etc.

The warning instructions 16b comprise instructions relating to the traffic in front of the vehicle. To this end, the third display facility 11 is designed to emphasis and/or mark traffic signs, pedestrians, vehicles and hazard sources. The fourth display facility 12 is designed for a panorama-like display of rear-end information 17. It can therefore be called a “panorama rear-view screen”. The fourth display facility 12 can replace or supplement a function of a rear-view mirror in the vehicle in that it displays the course of the road, traffic and/or possible hazard sources in the rear region and behind the vehicle.

To display the navigation and/or warning instructions 16 and/or the rear-end information 17 the vehicle is equipped with a plurality of cameras and approximation sensors. The cameras and/or approximation sensors are designed to capture data for the navigation and/or warning instructions 16 and/or rear-end information 17 and to transmit these to the information display arrangement 1.

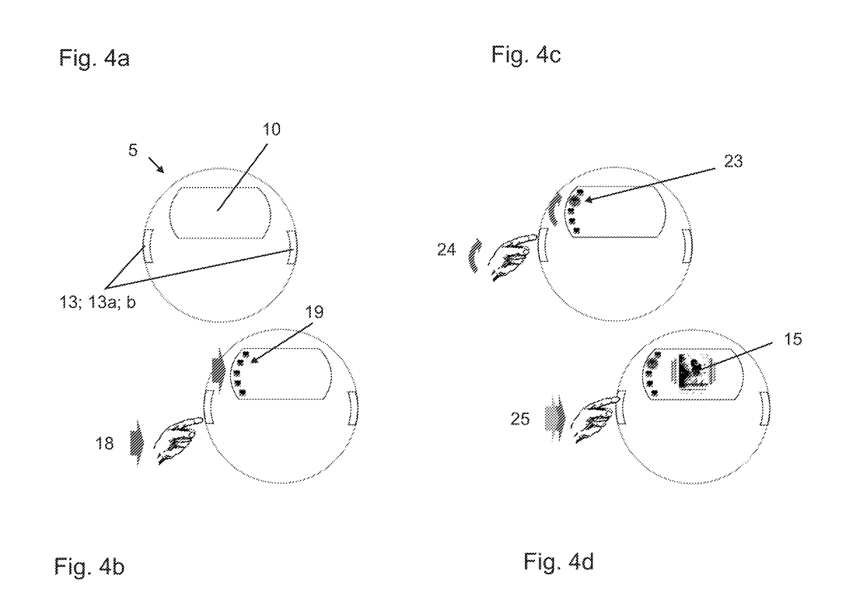

FIG. 4a, FIG. 4b, FIG. 4c, FIG. 4d each show a front view of the steering facility 5, of the operating facility 13 and of the second display facility 10. In the FIG. 4b, FIG. 4c, FIG. 4d different operating and/or function states of the operating and display facility 13; 10 are shown. FIG. 4 shows the operating facility 13 that is formed through the two touch-sensitive surfaces 13 on the outer ends of the control levers. The control levers are arranged on the left and right side of the steering facility 5.

The touch-sensitive surfaces 13 each comprise two surface portions 13a; b. In the exemplary embodiments of the FIG. 4b, FIG. 4c, FIG. 4d only the operation of the surface portions 13a; b arranged on the left is shown. In an alternative exemplary embodiment the surface portions 13a; b arranged on the right can also be operated in the same or in a similar manner. FIG. 4b shows that the touch-sensitive surface 13 arranged on the left is designed to activate the second display facility 10 through a once-off tipping 18 onto the first surface portion 13a and to display a user menu 19. In the user menu 19 links 23 are shown which upon activation lead to the secondary information 15. FIG. 4c shows that the vehicle driver 7 through a direction-guided stroking movement 24 on the first surface portion 13a can move and position a cursor in the user menu 19 onto the link 23 desired by said driver. In FIG. 4d it is shown that the vehicle driver 7 can select and activate the link 23 by twice tipping 25 onto the first surface portion 13a. Following this, the second display facility 10 displays the linked secondary information 15.

In alternative embodiment the once-off tipping 18 can also take place on the second surface portion 13b, as a result of which the first display facility 9 is switched on and the primary information 14 is displayed. Through the direction-guided stroking movement 24 on the second surface portion 13b the cursor can be shifted within the primary information 14. The selected primary information 14 can again be selected and changed if required by tipping 25 twice onto the second surface portion 13b. Similar can also be the case with the operation of the surface 13 arranged on the right next to the steering facility 5, particularly with the surface portions 13a; b arranged there. With these, the operation of the third and fourth display facility 11; 12 is ensured.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An information display arrangement for a vehicle, comprising:
a dashboard;
a steering arrangement comprising a steering facility and a steering column;
a first display facility that in a viewing direction of a position for a vehicle driver is arranged behind the steering facility in the dashboard; and
a second display facility arranged on the steering column.

2. The information display arrangement according to claim 1, further comprising:
A first eye distance between the first display facility and the position of the vehicle driver; and
a second eye distance between the second display facility and the position of the vehicle driver, the second eye distance is smaller than the first eye distance.

3. The information display arrangement according to claim 1, wherein the second display facility is arranged in a roof direction from a vehicle roof to a vehicle floor below the first display facility.

4. The information display arrangement according to claim 1, further comprising a third display facility that is implemented in a windshield of the vehicle.

5. The information display arrangement according to claim 4, further comprising a fourth display facility that is arranged adjacent to the first display facility in the dashboard.

6. The information display arrangement according to claim 5, wherein at least two of the first display facility, the second display facility, the third display facility and the fourth display facility are arranged step-like in an interior of the vehicle.

7. The information display arrangement according to claim 1, wherein the first display facility is configured to display primary information.

8. The information display arrangement according to claim 1, wherein the second display facility is configured to display secondary information.

9. The information display arrangement according to claim 4, wherein the third display facility is configured to display navigation instructions.

10. The information display arrangement according to claim 4, wherein the third display facility is configured to display instructions.

11. The information display arrangement according to claim 5, wherein the fourth display facility is configured to display rear-end information.

12. The information display arrangement according to claim 7, wherein the information display arrangement is configured to reduce a load on the vehicle driver with a visual perception of the primary information.

13. The information display arrangement according to claim 5, further comprising an operating facility configured to operate at least one of the first display facility, the second display facility, the third display facility or the fourth display facility, the operating facility comprises a touch-sensitive surface.

14. The information display arrangement according to claim 13, wherein the operating facility is arranged adjacent to the steering arrangement.

15. The information display arrangement according to claim 13, wherein the touch-sensitive surface is arranged radially to an imaginary straight line through a center of the steering facility.

16. The information display arrangement according to claim 13, wherein the touch-sensitive surface comprises a first touch-sensitive surface portion and a second touch-sensitive surface portion.
